(19) United States
(12) Patent Application Publication
(10) Pub. No.: US 2026/0208877 A1
(43) Pub. Date: Jul. 23, 2026

(54) WATER SUPPLY SYSTEM AND AIRCRAFT WITH WATER SUPPLY SYSTEM

(71) Applicant: Airbus Operations GmbH, HAMBURG (DE)

(72) Inventors: Matthias HEGENBART, HAMBURG (DE); Frederik ALBERS, HAMBURG (DE)

(21) Appl. No.: 19/453,368

(22) Filed: Jan. 20, 2026

(30) Foreign Application Priority Data
Jan. 22, 2025 (DE) 102025000241.6

(51) Int. Cl. B64D 45/00; B64D 11/02; B64D 11/04

(52) U.S. Cl. CPC B64D 45/00; B64D 11/02; B64D 11/04; B64D 2045/0085

(57) ABSTRACT

A water supply system which has two pumping devices which are operated such that the respective value of an operating parameter, such as an operating pressure or an operating time, is different. Pipes connect the pumping devices to water consumers and a valve is provided to connect or disconnect the pumping devices from the piping networks. Also an aircraft with such a water supply system.

### CROSS-REFERENCE TO RELATED APPLICATIONS

This application claims the benefit of German Patent Application No. 10 2025 000 241.6, filed on Jan. 22, 2025, the entire disclosure of which is incorporated herein by way of reference.

### FIELD OF THE INVENTION

The present disclosure relates to a water supply system for an aircraft and to an aircraft with such a water supply system. In particular, the present disclosure relates to a water supply system with two redundant pumping units that are operated differently.

### BACKGROUND OF THE INVENTION

Conventional water supply systems in aircraft circulate water from a main tank through a network at a pressure that depends on the pressure required by the water consumers. For example, a pumping unit is selected or designed to provide a water pressure that matches the pressure of the furthest water consumer (the one with the greatest pressure loss within the piping network).

In aircraft, supply systems typically need to be redundant so that in the event of a malfunction or failure of one component, another component can take over. For example, in conventional water supply systems, bleed air from an engine may be used to maintain or restore pressure in the pipe network if the pumping system failed.

Another water supply system, for example, includes a high-pressure system that uses smaller and, above all, more flexible pipes through which water is transported at a pressure higher than required by the water consumers. A central main tank and buffer storage tanks at the individual water consumers are usually kept at ambient pressure.

Therefore, compressed air cannot be used to force water through the pipe network.

Instead, such high-pressure water supply systems are designed so that two pumping units deliver water from a central main tank to different areas of the piping network. For example, one pumping unit could deliver water to water consumers in the front of the aircraft, while another pumping unit delivers water to water consumers in the rear. In the event of a failure of one of the pumping units, a cross-separation valve is provided, which can connect the lines of the respective piping network areas downstream of the two pumping units. This allows the entire piping network to be supplied with water from just one pumping unit in an emergency.

Even such high-pressure water supply systems can be improved further.

Therefore, a purpose of the present disclosure is to provide an improved water supply system and a suitably equipped aircraft.

### SUMMARY OF THE INVENTION

This problem may be solved by the present invention as described in one or more embodiments herein.

According to a first aspect for a better understanding of the present disclosure, a water supply system for an aircraft comprises a first pumping device or unit configured to convey water into a first piping network, a second pumping device or unit configured to convey water into a second piping network, and a cross-switching valve configured to fluidically connect or disconnect the first and second piping networks downstream of the first and second pumping devices.

The water supply system also includes a control unit that is connected to at least the first and second pumping units and the cross-switching valve. Furthermore, the control unit is configured to operate the first pumping unit according to a first operating parameter and the second pumping unit according to a second operating parameter. The first operating parameter differs from the second operating parameter.

This means that the water supply system is redundant, since if one pumping device fails, water can still be pumped into the entire pipe network (the first and second pipe network) via the cross-switching valve.

The different operating modes of the pumping equipment ensure that one pumping unit exhibits less wear and tear than the other. This prevents a situation where both pumping units fail at the same time or within a short period. Because the pumping units are typically identical in design, the wear and tear on both units is not the same, as is usually the case. Therefore, the present disclosure reduces the probability that the second pumping unit will also fail if the first fails. For example, while the second pumping unit is subjected to a greater load when the first fails, as more water must be pumped to supply the entire pipeline network, it exhibits less wear and tear, thus maintaining redundancy in the water supply system.

In one implementation variant, the first operational parameter can be the runtime of the first conveyor system during a flight, and the second operational parameter can be the runtime of the second conveyor system during the flight. Since the values of the first and second operational parameters are different, one of the two conveyor systems runs longer per flight than the other. This reduces the failure risk of the conveyor system with the shorter runtime and makes a simultaneous or very close-range failure of both conveyor systems less likely.

In one implementation variant, the runtime of the first conveying unit can be longer than the runtime of the second conveying unit. The control unit is therefore configured to run the first conveying unit more frequently or for longer periods during a flight than the second conveying unit.

Instead of the operating time of the respective conveying system during a flight, the operating size can also refer to the total operating time of the respective conveying system.

In one implementation variant, the first operating parameter can be the operating pressure of the first pumping unit, and the second operating parameter can be the operating pressure of the second pumping unit. The pumping unit with the higher operating pressure can, for example, be used to supply the pipe network with the greatest pressure loss from the first and second pipe networks. As an example, if one of the two pumping units fails, the control unit can be configured to control the remaining pumping unit to operate at a higher pressure than before. This allows the entire pipe network to be supplied.

As just one example, the operating pressure of one of the two pumps can be zero for normal operation of the water supply system. In other words, the control unit is configured to operate only one pump and control the cross-seal valve to supply the entire pipe network (the first and second pipe networks) with water. If the water supply system requires more water than usual (for example, when many water consumers are using it simultaneously), the control unit can also be configured to operate the pump with the original zero operating pressure at a pressure greater than zero. This pump is then only operated during periods when the water pressure in the entire pipe network must be above a certain threshold to supply all water consumers with sufficient water. This results in one pump wearing out more than the other, thus reducing the probability of simultaneous failure.

In one implementation variant, the control unit can be configured to adjust the cross-slide valve so that the first and second pipe networks are fluidically connected while either the first or the second pumping unit is operating. In other words, only one of the first and second pumping units is operated by the control unit, which in turn supplies the entire pipe network with water. This allows, for example, the operating time and/or operating pressure of one of the first and second pumping units to be greater than that of the other.

In one implementation variant, the control unit can be configured to adjust the cross-slide valve so that the first and second pipeline networks are fluidically connected, while the first and second pumping units operate simultaneously. In other words, both pumping units operate concurrently. However, the operating parameters, such as the operating pressure, flow rate, feed rate, and/or velocity of the two pumping units, may differ between the first and second units.

In one implementation variant, the control unit can be configured to adjust cross-switching valves so that the first and second piping networks are fluidically separated, while the first and second pumping units operate simultaneously. Here, the operating parameter can be a runtime per flight and/or an operating pressure of the pumping unit. As just one example, the first and second piping networks can be configured differently, with water consumers in one network requiring less frequent water supply and/or a lower operating pressure from the associated pumping unit being sufficient to supply all water consumers in that network.

In one implementation variant, the water supply system can further include a first pressure sensor that measures the output pressure of the first pumping device. The control unit can, for example, also be configured to receive a signal from the first pressure sensor in order to control the associated first pumping device.

In one implementation variant, the water supply system can further include a second pressure sensor that measures the output pressure of the second pumping device. Here, too, the control unit can be configured, for example, to receive a signal from the second pressure sensor in order to control the associated second pumping device.

In the event of a failure of the first or second conveying unit, the control unit can also operate the still functioning conveying unit based on the signal from the first or second pressure sensor or based on the signals from the first and second pressure sensors.

In one implementation variant, the control unit can further be configured to monitor at least one parameter of the first and second conveying devices. This at least one parameter can include the total operating time of the conveying device, a current operating pressure or a value mathematically calculated from the current operating pressure over time (for example, an average, a maximum value, a number of events at which the maximum operating pressure of the conveying device was present, etc.), a flow rate, a flow rate, a rotational speed of the conveying device or a value mathematically calculated from a current rotational speed of the conveying device over time (for example, an average, a maximum value, a number of events at which the maximum rotational speed of the conveying device was present, etc.), a temperature of the conveying device, an operating noise (for example, recorded by a microphone or other acoustic sensor), a current voltage of the conveying device's power supply, a current current (in amperes) of the conveying device's power supply, and similar parameters.

In one implementation variant, the control unit can also be configured to output a signal indicating the operational readiness of the first and/or second conveying unit. For example, the control unit can determine the operational readiness of the conveying unit based on the total operating time (e.g., greater than or equal to 95% of the maximum operating time specified by the manufacturer), the frequency with which maximum values are reached, the total flow rate through the conveying unit, a specific operating noise level, and/or the current (or power) consumption of the conveying unit.

In one implementation variant, the control unit can also be configured to output a signal indicating wear of the first and/or second conveying element. This can be determined by the control unit using the same or similar parameters as those used to assess the operational readiness of the conveying element as described above. For example, the control unit can be configured to estimate the wear of the first and/or second conveying element using templates or machine learning.

In one implementation variant, the control unit can also be configured to send the signal to a component in the aircraft and/or to transmit the signal to an aircraft-internal network and/or an aircraft-internal bus. This enables the central acquisition of the signal in a component of the aircraft and/or in a station outside the aircraft (for example, in a central ground station of the aircraft operator). This allows for the planning of the servicing and/or replacement of one or both of the conveyor systems.

In the present disclosure, the term “water consumers” may be used in some places. However, this should not be understood to mean that a multiple water consumers must actually be installed. Rather, a single water consumer may be provided for in one of the two pipe networks or in the entire pipe network.

The water supply system described in this disclosure is illustrated with examples where one pumping device fails earlier than another, or where the probability of earlier failure is higher. Of course, this disclosure is not intended to address the actual failure of a pumping device; rather, this serves only to describe the functionality and advantages of the disclosure. Instead, the pumping device subject to greater wear due to different operating conditions can be replaced earlier. This can also be managed so that only one pumping device needs to be replaced at specific service intervals, while the other can continue to operate for a longer period.

According to a second aspect for a better understanding of the present disclosure, an aircraft includes a water supply system according to the first aspect or one or more of the associated implementation variants.

The present disclosure is not limited to the aspects and variants in the form and order described herein. Nor should the description of these aspects and variants be understood as a specific, restrictive grouping of features. Rather, the present disclosure also covers combinations of the implementation variants described herein.

### BRIEF DESCRIPTION OF THE DRAWINGS

The present disclosure is described below with regard to exemplary implementations shown in the figures, wherein

FIG. 1 schematically represents a water supply system for an aircraft;

FIG. 2 schematically shows a detailed view of the water supply system; and

FIG. 3 schematically depicts an aircraft with a water supply system.

### DETAILED DESCRIPTION OF THE PREFERRED EMBODIMENTS

In the following description, certain details are explained solely for the purpose of understanding the present disclosure, but not to limit the present disclosure to these details. It is obvious to those skilled in the art that the present disclosure can also be implemented in other variants that differ from these specific details.

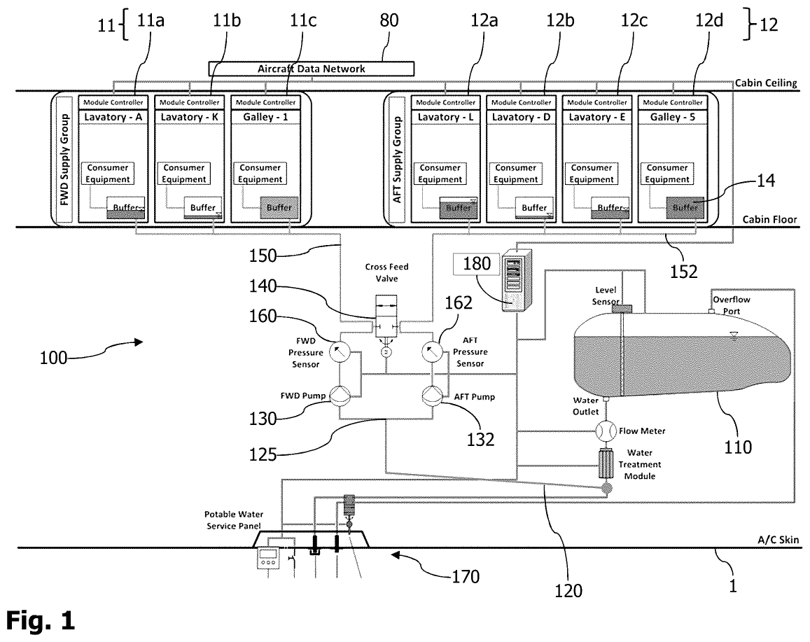

FIG. 1 schematically shows a water supply system 100 for an aircraft 1 in a longitudinal cross-sectional view of the aircraft 1. The aircraft skin (A/C skin) of the aircraft 1 is shown below, in which a water connection 170 (Potable Water Service Panel) may be provided, through which water can be supplied to or drained from the water supply system 100. While the majority of the water supply system 100 is located below a cabin floor, several water consumers 11, 12 are typically located above the cabin floor and below a cabin ceiling. By way of example only, an aircraft data network 80 may be installed above the cabin ceiling, which connects at least some of the components of the aircraft 1 via data lines.

Water consumers 11, 12 include, for example, aircraft toilets 11a, 11b, 12a, 12b, 12c (lavatory) and galleys 11c, 12d. Some of these water consumers 11, 12 may be grouped together. FIG. 1 shows, by way of example, a forward group (FWD Supply Group) and a rear group (AFT Supply Group), which are located at the front and rear of the aircraft 1, respectively. “Front” and “rear” here refer, for example, to the center of the aircraft 1, such as in the wing area, since a main water tank 110 and other central components of the water supply system 100 are often located in this area. The water supply system 100 includes (usually also in this central location within the aircraft 1) a main water line 120 in addition to the main water tank 110.

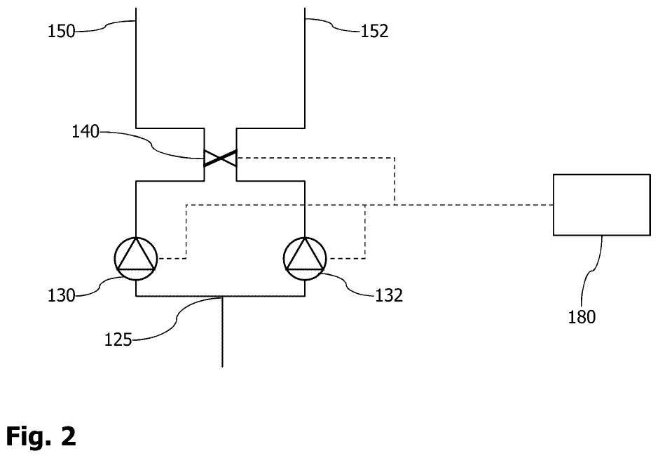

With reference to FIGS. 1 and 2, the latter of which shows a detail of the water supply system 100, the water supply system 100 further comprises a first pumping unit 130 (FWD Pump), which is configured to pump water into a first pipeline network 150 (from the main water line 120), and a second pumping unit 132 (AFT Pump), which is configured to pump water into a second pipeline network 152 (from the main water line 120). Both pumping units 130 and 132 are connected upstream to the main water line 120, which forms two branches leading to the respective pumping units 130 and 132 at a junction 125.

The two pipeline networks 150, 152 are fluidically connected downstream of the first and second pumping devices 130, 132 by a cross-switching valve 140, or can be fluidically separated by the cross-switching valve 140. This allows water to be pumped from the main line 120 through one or both of the pumping devices 130, 132 into one or both of the pipeline networks 150, 152, and thus to the respective consumers 11, 12.

The water supply system 100 further comprises a control unit 180, which is connected at least to the first and second pumping units 130, 132 and the cross-switching valve 140 (for example, via (electrical) lines shown as dashed lines in FIG. 2). The control unit 180 is configured to operate the first pumping unit 130 according to a first operating parameter and to operate the second pumping unit 132 according to a second operating parameter. One value of the first operating parameter differs from one value of the second operating parameter.

As an example only, the water supply system 100 can include a first pressure sensor 160 (FWD Pressure Sensor) and a second pressure sensor 162 (AFT Pressure Sensor), which are located downstream of the first and second pumping devices 130 and 132, respectively, and measure the respective output pressure of the first and second pumping devices 130 and 132. The control unit 180 can be configured to operate the two pumping devices 130 and 132 with different output pressures. This can be done by the control unit 180 based on output signals from the associated pressure sensors 160 and 162.

Another or additional operating parameter of the two conveying systems 130, 132 can be the operating time of each system. In particular, this can refer to the operating time during a flight (i.e., the operating time per flight). By operating the two conveying systems 130, 132 with different operating times per flight, one of the conveying systems 130, 132 is effectively protected. This increases the probability that the “protected” conveying system 130, 132 will fail later or can be replaced at a later time (even before the actual failure).

Naturally, the operating time per flight for one of the two conveyor systems 130, 132 can be longer than for the other over several flights. Conversely, it is also possible that the conveyor systems 130, 132 are operated alternately for longer or shorter periods over several flights. Overall, however, the control system is configured to utilize one of the conveyor systems 130, 132 more intensively than the other in order to achieve the time staggered interval between failure and replacement of the respective conveyor system 130, 132.

The control unit 180 can adjust the cross-switching valve 140 so that the first and second pipeline networks 150, 152 are either fluidically connected or fluidically separated. Furthermore, the control unit 180 can operate the first and/or second conveying device 130, 132 in any position of the cross-switching valve 140. The conveying devices 130, 132 can be operated alternately, sequentially, simultaneously, or completely independently of each other.

Furthermore, the control unit 180 can be configured to monitor at least one parameter of the first and second conveying devices 130, 132 and to output a corresponding signal regarding the operational capability and/or wear of the first and/or second conveying devices 130, 132. This signal can, for example, be transmitted to the aircraft data network 80, enabling the maintenance and/or replacement of one of the conveying devices 130, 132 to be scheduled centrally. For example, the control unit 180 or the central location can compare the operational capability and/or wear of the respective conveying device 130, 132 with a threshold value to determine that the corresponding conveying device 130, 132 should be replaced during the next maintenance of the aircraft 1.

The water supply system 100 shown in FIG. 1 is configured such that each water consumer 11, 12 includes a buffer storage tank 14 (buffer) which can be filled with water via the respective pipeline network 150, 152. The actual water-consuming component (consumer equipment) is, for example, a tap, a shower, a toilet (flush), a water heater, a coffee machine, and the like. This component is supplied from the buffer storage tank 14.

Both the buffer storage tank 14 and the main water tank 110 can be operated without pressure in such a system, which simplifies these sections of the water supply system 100. The pumping devices 130, 132 are designed to convey water from the main line 120 into the respective pipeline network 150, 152 at a pressure greater than that of the individual water-consuming components. This higher pressure allows the use of different pipes in the pipeline network 150, 152 than is usually required. In particular, pipes with a significantly smaller (inner) diameter than conventional water pipes in aircraft can be used, which also allows the use of more flexible materials, for example, plastic instead of metal.

This not only reduces the weight of the pipeline networks 150, 152, but also simplifies the pipe routing within the aircraft 1.

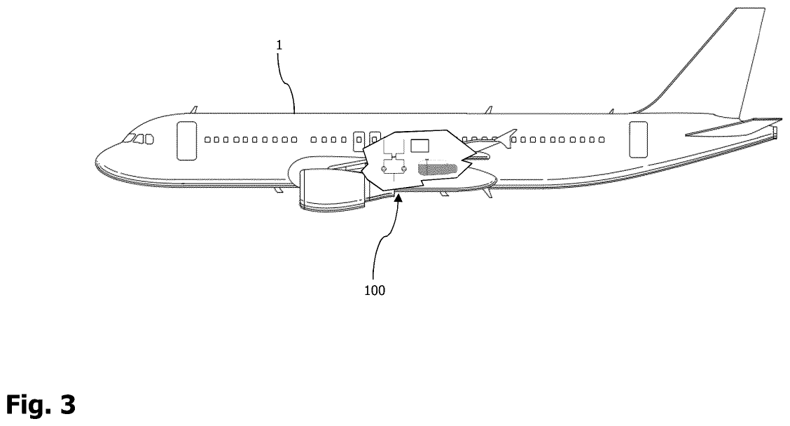

Finally, FIG. 3 schematically shows an aircraft 1 that includes a water supply system 100. The water supply system 100 can be located at any point within the aircraft.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A water supply system for an aircraft, comprising:
a first conveying device configured to pump water into a first pipeline network;
a second conveying device configured to pump water into a second pipeline network;
a cross-switching valve configured to fluidically connect or disconnect the first and second pipeline networks downstream of the first and second conveying devices; and
a control unit which is connected to the first and second conveying devices and the cross-switching valve and is configured to:
operate the first conveying device according to a first operating parameter, and
operate the second conveying device according to a second operating parameter,
wherein a value of the first operational parameter differs from a value of the second operational parameter.

2. The water supply system according to claim 1, wherein the first operating parameter is a runtime of the first conveying device during a flight, and the second operating parameter is a runtime of the second conveying device during the flight.

3. The water supply system according to claim 1, wherein an operating time of the first conveying device is longer than an operating time of the second conveying device.

4. The water supply system according to claim 1, wherein the first operating parameter is an operating pressure of the first conveying device, and the second operating parameter is an operating pressure of the second conveying device.

5. The water supply system according to claim 1, wherein the control unit is further configured to:
adjust the cross-switching valve so that the first and second pipeline networks are fluidically connected while the first conveying device or the second conveying device is operating, or
adjust the cross-switching valve so that the first and second pipeline networks are fluidically connected while the first conveying device and the second conveying device are operated simultaneously, or
adjust the cross-switching valve so that the first and second pipeline networks are fluidically separated, while the first conveying device and the second conveying device are operated simultaneously.

6. The water supply system according to claim 1, further comprising:
a first pressure sensor configured to measure an outlet pressure of the first conveying device; or
a second pressure sensor configured to measure an output pressure of the second conveying device; or
both.

7. The water supply system according to claim 1, wherein the control unit is further configured to:
monitor at least one parameter of the first conveying device, the second conveying device, or both, and,
output a signal indicating that the first conveying device, the second conveying device, or both is operational, or
output a signal indicating wear of the first conveying device, the second conveying device, or both,
or output both.

8. An airplane comprising:
the water supply system according to claim 1.
